(19) United States
(12) Patent Application Publication
(10) Pub. No.: US 2021/0044189 A1
(43) Pub. Date: Feb. 11, 2021

(54) SHORT-CIRCUIT RING FOR CONNECTING TO CAGE BARS

(71) Applicant: Siemens Aktiengesellschaft, 80333 München (DE)

(72) Inventors: JÖRG MÜLLER, Nüdlingen (DE); ALEXANDRA SCHNEIDER, Heustreu (DE); DIETMAR STREIT, Oberstreu (DE)

(73) Assignee: Siemens Aktiengesellschaft, 80333 München (DE)

(21) Appl. No.: 16/965,881

(22) PCT Filed: Dec. 21, 2018
(86) PCT No.: PCT/EP2018/086522

§ 371 Date: Jul. 29, 2020

(30) Foreign Application Priority Data
Jan. 30, 2018 (EP) 18154071.7

(51) Int. Cl. H02K 17/16; H02K 15/00

(52) U.S. Cl. CPC H02K 17/165; H02K 2213/12; H02K 15/0012

(57) ABSTRACT

In a method, a short-circuit ring for a squirrel cage of an electric machine is produced through an automated additive production method in one piece with a recess for receiving one end of a cage bar. Material is introduced into a well with a well contour adjacent to the recess on a front axial end of the short-circuit ring through the additive production method, and introduction of the material is repeated into further such wells until all the wells to be filled have been provided with the material, so that the short-circuit ring is connected to the cage bars in an electrically conductive and mechanically robust manner.

The invention relates to a short-circuit ring for a squirrel cage of an electric machine, wherein the short-circuit ring has at least one recess, preferably multiple recesses, for receiving at least one cage bar, preferably multiple cage bars, wherein the short-circuit ring is embodied to receive one end of the cage bar.

To form a squirrel cage for a squirrel-cage rotor, at least one short-circuit ring is connected to cage bars, the cage bars preferably being connected both at a front axial end and also at a rear axial end to one short-circuit ring in each case. This connection must be embodied to be electrically conductive.

To this end, the patent specification DE 3834466 C1 discloses a squirrel-cage rotor for an electric machine in which the ends of the cage bars projecting out of the slots on both end faces of the laminated rotor core protrude into an annular well of the short-circuit ring delimited by an inner and outer edge on the end face, and are electrically and mechanically connected to the short-circuit ring by means of hard solder which has been introduced into the annular well, melted in the annular well by means of simultaneous heating of the entire short-circuit ring, and then solidified.

Where the connection is implemented by means of the hard-soldering method, however, it is necessary to observe soldering gaps, which are difficult to produce in a reliable manner.

The object underlying the invention is to improve a connection between short-circuit ring and cage bars.

The object is achieved by a short-circuit ring as claimed in claim 1, in other words a short-circuit ring for a squirrel cage of an electric machine, wherein the short-circuit ring has at least one recess, preferably multiple recesses, for receiving at least one cage bar, preferably multiple cage bars, wherein the short-circuit ring is embodied to receive one end of the cage bar, wherein a well with a well contour is embodied adjacent to at least one recess at a front axial end of the short-circuit ring.

The object is further achieved by a method as claimed in claim 10, in other words a method for producing a short-circuit ring of this kind.

The object is further achieved by a method as claimed in claim 11, in other words a method for connecting a short-circuit ring of this kind to at least one cage bar, preferably multiple cage bars, in order to produce a squirrel cage.

The object is further achieved by a squirrel cage as claimed in claim 14, in other words a squirrel cage for an electric machine produced according to a method of this kind, and by an electric machine as claimed in claim 15.

In an advantageous embodiment of the invention, the short-circuit ring is embodied to receive one end of the cage bar from a rear axial end of the short-circuit ring up to an interface.

This has the advantage that the short-circuit ring is connected mechanically to one or more cage bars.

In a further advantageous embodiment of the invention, the well is embodied from the front axial end of the short-circuit ring up to the interface. Advantageously, the end of the cage bar and the well are adjacent to one another.

This has the advantage that the short-circuit ring can be produced more easily.

The short-circuit ring is advantageously produced in one piece.

In a further advantageous embodiment of the invention, the well contour corresponds to a recess contour. Advantageously, the recess contour corresponds to a contour of the cage bar.

This has the advantage that the short-circuit ring can be produced more easily.

In a further advantageous embodiment of the invention, the well contour is circular in shape.

This has the advantage that applied forces, occurring for example during operation of an electric machine and thus acting on the squirrel cage (where there is an existing connection between short-circuit ring and cage bars), are distributed evenly, in particular in the case of cage bars with a circular cross-section.

In a further advantageous embodiment of the invention, the well contour corresponds to an enlarged or reduced shape of the recess contour.

This has the advantage that, when the cage bar is received by the short-circuit ring, a particularly good form-fit and positive-fit connection is established between the short-circuit ring and the cage bar.

In a further advantageous embodiment of the invention, the well contour surrounds at least two recess contours.

This has the advantage that the short-circuit ring can be produced more easily by means of additive or subtractive production methods.

In a subtractive processing of the short-circuit ring, e.g. machining, in particular to form the well, a milling tool for example does not need to form a well adjacent to every recess, but can instead form a well adjacent to two or more recesses. As a result, production can take place more quickly.

Additive production, too, takes place more quickly in this embodiment.

This embodiment is also advantageous in the method for connecting a short-circuit ring of this kind to at least one cage bar, preferably multiple cage bars, in order to produce a squirrel cage. When establishing the connection, in particular by means of an additive method, it is not necessary here to fill each well one by one with a material for establishing the connection, but instead the connection can be established for two or more recesses together. This saves time and thus costs.

In a further advantageous embodiment of the invention, a length in the radial direction of the short-circuit ring of the well contour corresponds substantially to a length in the radial direction of the short-circuit ring of the recess, and the well is adjacent to at least two recesses.

In a further advantageous embodiment of the invention, a number of wells corresponds to a number of recesses.

This has the advantage that each cage bar can be connected optimally to the short-circuit ring, thus enabling a high degree of stability to be achieved.

The cage bars are preferably arranged in slots of a rotor core, in particular laminated rotor core. Ends of the cage bars preferably project out of the rotor core. The ends of the cage bars preferably project out of the rotor core at a front axial end of the rotor core and at a rear axial end of the rotor core.

A short-circuit ring is preferably embodied on the front and rear axial end of the rotor core.

In a further advantageous embodiment of the invention, at least one short-circuit ring, preferably both short-circuit rings, is/are embodied as an axially spaced short-circuit ring.

On account of the spacing of one or both short-circuit rings, a gap is embodied between the short-circuit ring and the axial end of the rotor core, said gap enabling an effective cooling of the short-circuit ring.

The invention further comprises a method for producing a short-circuit ring of this kind by means of an additive production method.

The short-circuit ring is advantageously produced in one piece.

Various additive production methods are available for this purpose. Advantageously, however, the 3D metal print method PUMP) is used as the additive production method, since this has the advantage of clean and rapid production.

Other additive production methods can however be used to produce a short-circuit ring of this kind.

The invention further comprises a method for connecting a short-circuit ring of this kind to at least one cage bar, preferably multiple cage bars, in order to produce a squirrel cage with the following steps: joining the short-circuit ring and the cage bars; introducing at least one material into at least one well, preferably into all wells, by means of an additive method.

The short-circuit ring and the cage bars, in particular in the case of a spaced short-circuit ring, are advantageously joined so that they fit together precisely.

Other means can also be used in order to prevent an egress of material when connecting short-circuit ring and cage bars.

Advantageously, the short-circuit ring and the cage bars are joined and, during and/or after joining, a sealant is inserted to seal gaps between short-circuit ring and cage bar.

In an advantageous embodiment of the invention, the additive method is an additive arc-welding method or a metal powder application method (MPA) or a 3D metal print method (3DMP).

Other additive production methods are however also suitable.

The additive method offers the advantage that a material-bonded connection is achieved at the same time as the material is deposited. This material-bonded connection is optimal with regard to its electrical and mechanical properties.

The additive method also offers the advantage that it is embodied to be carried out in a fully automated manner. This enables a reliable method. In addition, the additive method offers the advantage that in particular small series and/or prototypes can be produced flexibly and rapidly, even taking changed geometries into consideration.

The additive method is advantageously integrated into the production process for producing the electric machine.

Welding is described as an additive arc-welding method when volume is bunt up by means of a weld filler material, for example wire or powder, with the application of heat. Here, the weld filler material is applied layer by layer and melted to form a material bond with a component to be connected or the layer disposed therebelow, thus producing a build-up of volume.

Methods based on a similar principle and therefore also suitable include for example: laser deposition welding method or plasma powder deposition welding method, DMD method (direct metal deposition), LMD method (laser metal deposition) and 3DMP method (3D metal print).

In the MPA method, a main gas, preferably steam, is accelerated in a converging-diverging nozzle. Powder particles are injected just before the converging-diverging point. The powder particles are accelerated to supersonic speed and strike a substrate or a component accordingly. The high magnetic energy of the powder particle is converted to heat on impact, whereby the particle adheres. Since the powder particles are not melted, only a low energy input into the component takes place. In the MPA method, a plurality of nozzles can apply various powder particles at the same time. In this way, it is also possible to produce a component having at least two different materials.

The 3DMP method is based on the arc-welding method and uses wire as the starting material. Using this method, a workpiece is printed welding bead by welding bead. The 3DMP method offers the advantage that many materials are already available as wire, but not as powder. Moreover, wire as material is more cost-effective than material in powder form. The 3DMP method also offers a high build-up rate.

In a further advantageous embodiment of, the invention, the material is aluminum or copper or alloys thereof. The two materials aluminum and copper represent the best possible option in terms of price and conductivity for forming an electrically conductive connection.

The electrically conductive connection between short-circuit ring and cage bars is realized advantageously with a material that is already contained in the cage bars or of which the cage bars consist, preferably copper. This has the advantage that only low adhesive forces are present and, as a result, the connection can be embodied to be resistant to mechanical stresses.

A squirrel cage is advantageously produced by means of the method described. It therefore has good properties in terms of resistance to mechanical stresses and conductivity.

An electric machine with a squirrel-cage rotor advantageously has the squirrel cage described. The electric machine is robust and has optimal properties in terms of its conductivity in the rotor.

The electric machine is preferably embodied as a dynamo-electric rotary machine.

The electric machine is preferably operated as a motor.

The invention is described and explained in more detail below on the basis of the exemplary embodiments shown in the figures, in which:

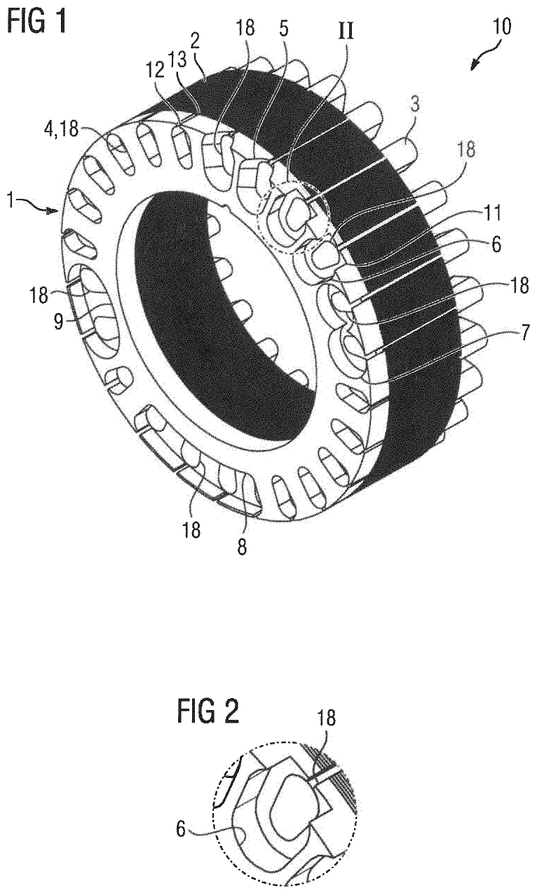

FIG. 1 shows a squirrel-cage rotor of an electric machine,

FIG. 2 shows a section of a well type 3 from FIG. 1,

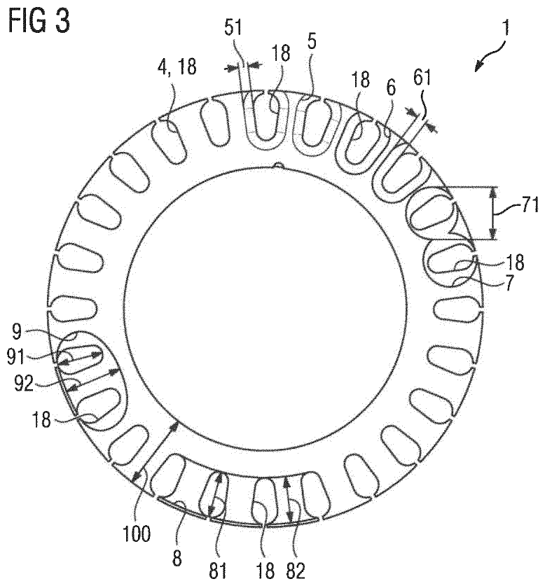

FIG. 3 shows a front view of the short-circuit ring,

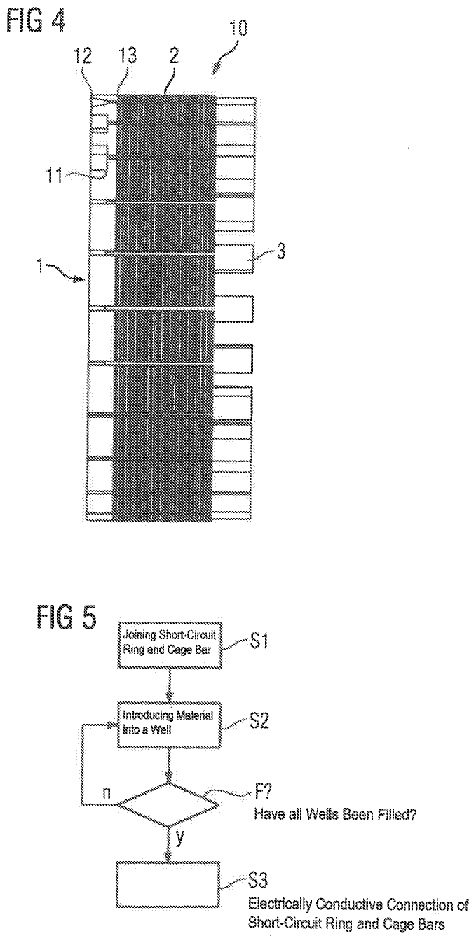

FIG. 4 shows a side view of the squirrel-cage rotor, and

FIG. 5 shows a method for connecting a described short-circuit ring to at least one cage bar, preferably multiple cage bars, in order to produce a squirrel cage.

FIG. 1 shows a squirrel-cage rotor 10 of an electric machine. The squirrel-cage rotor 10 has a short-circuit ring 1 and cage bars 3, The cage bars are arranged in slots of a laminated core 2. The short-circuit ring 1 has a front axial end 12 and a rear axial end 13. FIG. 1 also shows an interface 11. The short-circuit ring 1 is embodied to receive one end of the cage bar 2 from a rear axial end 13 of the short-circuit ring up to an interface 11, The short-circuit ring has recesses for this purpose. The figure shows various possible types of wells, which are embodied at the front axial end 12 of the short-circuit ring 1.

The well type 1 is a well in which a well contour 4 corresponds to a recess contour 18.

In the well type 2, the well contour 5 is greater than the recess contour 18. The figure shows that the well type 2 slopes from the well contour 5 at the front axial end 12 of the short-circuit ring 1 in the axial direction obliquely to the recess contour 18 at the interface 11. The sloping region is indicated with 51.

The well type 3 also has a well contour 6, which is greater than the recess contour 18.

The figure shows however that the well type 3 slopes from the well contour 6 at the front axial end 12 of the short-circuit ring 1 in the axial direction directly to the recess contour 18 at the interface 11. This results in a chamfered well. The chamfering is indicated with 61.

The well type 4 has a circular well contour 7, which surrounds the recess contour 18 of the recess. The well contour 7 has a diameter 71.

If two wells with the well contour 7 and diameter 71 are disposed next to one another on the short-circuit ring 1, the two wells can interlock—as shown in the figure—on account of a size of the diameter 71.

The well type 5 with the well contour 8 surrounds multiple recesses, at least two recesses, and thus multiple recess contours 18. A length 82 in the radial direction 100 of the short-circuit ring 1 of the well contour 8 corresponds in the figure substantially to a length 81 in the radial direction 100 of the short-circuit ring 1 of the recess contour 18.

The well type 5 is adjacent to at least two recesses, in the figure to four recesses.

In the figure, the well type 6 with the well contour 9 surrounds two recesses with the recess contour 18. Here, a length 91 in the radial direction 100 of the short-circuit ring 1 of the recesses is less than a length 92 in the radial direction 100 of the short-circuit ring 1 of the well.

The well type 6 is embodied oval-shaped in the figure. However, other contours—for example in the shape of circles, triangles, rectangles or polygons—are possible for the wells type 1 to type 6 shown in the figure.

In the figure, the cage bars 3 extend up to an interface 11. It is however also possible that the cage bars 3 do not extend fully up to the interface 11 or that they protrude further into the short-circuit ring 1 in the direction of the front axial end 12 of the short-circuit ring 1.

The figure shows various possible wells. Advantageously, only one type is embodied for a short-circuit ring.

FIG. 2 shows a section of a well type 3 from FIG. 1. FIG. 2 shows an indented region, which results from the fact that the well contour 6 is greater than the recess contour 18.

FIG. 3 shows a front view of the short-circuit ring 1 with the features from FIG. 1.

FIG. 4 shows a side view of the squirrel-cage rotor 10. The interface 11 is shown clearly in the figure. The interface 11 is advantageously arranged in relation to an axial length of the short-circuit ring 1, which extends from the front axial end 12 to the rear axial end 13, after 10% to 90% of the axial length of the short-circuit ring 1 viewed from the front axial end 12.

FIG. 5 shows a method for connecting a described short-circuit ring to at least one cage bar, preferably multiple cage bars, in order to produce a squirrel cage.

In method step S1, the short-circuit ring and the cage bars are joined. In method step S2, at least one material is introduced into at least one well by means of an additive method. An additive arc-welding method is preferably used as the additive method.

F? indicates the question whether material has been introduced into all wells to be filled. If this is not the case—indicated with n—the next well is filled by means of the additive method in the method step S2. This is repeated until all wells to be filled have been provided with material—indicated with y. In method step S3, the short-circuit ring is as a result connected to the cage bars in an electrically conductive and mechanically robust manner.

1.-12. (canceled)

13. A method, comprising:
producing a short-circuit ring for a squirrel cage of an electric machine through an automated additive production method in one piece with a recess;
placing one end of a cage bar in the recess of the short-circuit ring;
introducing a material into a well with a well contour adjacent to the recess on a front axial end of the short-circuit ring through the additive production method; and
repeating introduction of the material into further such wells until all the wells to be filled have been provided with the material, so that the short-circuit ring is connected to the cage bars in an electrically conductive and mechanically robust manner.

14. The method of claim 13, wherein the additive production method is an additive arc-welding method or a metal powder application method or a 3D metal print method.

15. The method of claim 13, wherein the material is aluminum or copper or alloys thereof.

16. A short-circuit ring for an electric machine, produced by a method as set forth in claim 13.

17. The short-circuit ring of claim 16, comprising a recess for receiving one end of a cage bar from a rear axial end of the short-circuit ring up to an interface, said short-circuit ring comprising a well adjacent to the recess and extending from a front axial end of the short-circuit ring up to the interface and having a well contour which differs in shape and/or size from a recess contour.

18. The short-circuit ring of claim 17, wherein the well contour is circular in shape.

19. The short-circuit ring of claim 17, wherein the well contour corresponds to an enlarged or reduced shape of the recess contour.

20. The short-circuit ring of claim 17, wherein the well contour surrounds at least two of said recess contour.

21. The short-circuit ring of claim 17, wherein the well contour has a length in a radial direction of the short-circuit ring in substantial correspondence to a length of the recess contour in the radial direction of the short-circuit ring, said well being provided adjacent to at least two of said recess.

22. The short-circuit ring of claim 17, further comprising a number of said wells and a number of said recesses, wherein the number of wells corresponds to the number of recesses.

23. A squirrel cage for an electric machine, produced by a method as set forth in claim 13.

24. A squirrel cage for an electric machine, said squirrel cage comprising a short-circuit ring which includes a recess for receiving one end of a cage bar from a rear axial end of the short-circuit ring up to an interface, said short-circuit ring comprising a well extending from a front axial end of the short-circuit ring up to the interface and having a well contour which differs in shape and/or size from a recess contour.

25. The squirrel cage of claim 24, wherein the well contour is circular in shape.

26. The squirrel cage of claim 24, wherein the well contour corresponds to an enlarged or reduced shape of the recess contour.

27. The squirrel cage of claim 24, wherein the well contour surrounds at least two of said recess contour.

28. The squirrel cage of claim 24, wherein the well contour has a length in a radial direction of the short-circuit ring in substantial correspondence to a length of the recess contour in the radial direction of the short-circuit ring, said well being provided adjacent to at least two of said recess.

29. The squirrel cage of claim 24, wherein the short-circuit ring includes a number of said wells and a number of said recesses, wherein the number of wells corresponds to the number of recesses.

30. An electric machine, comprising a squirrel cage as set forth in claim 24.
